(19) United States
(12) Patent Application Publication
(10) Pub. No.: US 2015/0073888 A1
(43) Pub. Date: Mar. 12, 2015

(54) MOBILE PAYMENT AND POINT SYSTEM AND METHOD

(71) Applicant: PXT Payments, Inc., Andover, MA (US)

(72) Inventors: John Regan, Boxford, MA (US); Michael Irvine, Dunstable, MA (US); Keith Saunders, Kansas City, MO (US); Craig Henkels, Wenham, MA (US); Rivka Tadjer, Shokan, NY (US)

(73) Assignee: PXT Payments, Inc., Andover, MA (US)

(21) Appl. No.: 14/547,496

(22) Filed: Nov. 19, 2014

Related U.S. Application Data
(63) Continuation of application No. 13/410,527, filed on Mar. 2, 2012.
(60) Provisional application No. 61/448,287, filed on Mar. 2, 2011.

(51) Int. Cl. G06Q 30/02; G06Q 20/32

(52) U.S. Cl. CPC G06Q 30/0228; G06Q 30/0222; G06Q 20/322
USPC 705/14.23

(57) ABSTRACT

A system and method allows a consumer to purchase goods and services from merchants and redeem offers made by a merchant with a digital transaction on a smart phone. The merchant receives and enters the consumer's telephone number into an application. The consumer's telephone number is sent to a server, which checks for electronic coupons and loyalty points. Accounting for the value of any coupon/accumulated loyalty points, the merchant enters the payment amount into the application. which. in turn sends it back to the server. The server then sends the payment amount, any coupon details and the merchant's name to the consumer's phone. The consumer can choose to accept or decline the sale with or without using the coupon/loyalty points. A PIN number confirms the sale, which transmits to the server and then to the merchant. A digital sales receipt is sent to the merchant and consumer.

### CROSS-REFERENCE TO RELATED APPLICATIONS

This application is a continuation of U.S. patent application Ser. No. 13/410,527, filed Mar. 2, 2012, entitled “MOBILE PAYMENT AND POINT SYSTEM AND METHOD,” which claims the benefit under 35 U.S.C. §119(e) of the filing date of U.S. Provisional Patent Application Ser. No. 61/448,287, filed Mar. 2, 2011, entitled “PXT Mobile System.” The entirety of each of the foregoing documents is incorporated herein by reference in its entirety.

### FIELD

The present invention relates to mobile merchant and consumer payment services and more particularly, to a system and method for providing a system and method that allows consumers to pay for products and services utilizing a non-traditional money account and integrated electronic couponing and by which the consumer can verify and approve the transaction using their mobile electronic device such as a cell phone to purchase goods and services, including the payment of parking fees and to use, trade, sell and barter merchant specific points.

### BACKGROUND INFORMATION

Consumers purchase an ever increasing amount of goods and services utilizing non-cash financial transactions. An example of such a transaction is a consumer using their debit or credit card for purchases. In such situations, however, the consumer must either have the debit or credit card to swipe for payment or the consumer must give their debit or credit card information to the merchant for processing. This payment methodology focuses on a bank centric payment model and utilizes the merchant Point of Sale (POS) device. As everyone knows, identity theft or theft and misuse of debit/credit card information is widespread, particularly when a consumer has to give financial account information to a clerk at a merchant location, either in person or over the phone.

In addition, many merchants are now offering “points” programs. These points are merchant specific and are typically tied to purchases made by a consumer. For example, a merchant may offer a consumer one “point” for each $10.00 spent at the merchant. Each point may later be redeemable for $1.00 of merchandise at that merchant only. However, if the consumer moves or determines that they would rather have points at another merchant, there presently does not exist any mechanism for giving, selling, trading or bartering one's points at a first merchant for points at another merchant.

Accordingly, what is needed is a system and method of payment for goods or services that is not bank centric and wherein the user controls where payments come from and to whom they go by, for example, turning a smart phone into a replacement for cash, debit and credit cards all without having to disclose personal financial information to a merchant. All that should be needed is the consumer's telephone number. In addition, what is needed is a system that allows consumers simply redeem electronic coupons during the payment transaction; and to facilitate transfer of payments, offers (i.e. coupons) or merchant specific points directly between consumers.

### SUMMARY

The present invention is a fast, secure and convenient system and method to pay for goods and services at merchant stores and to receive and redeem electronic coupons (‘offers’) and/or merchant loyalty “points” at the time of sale—all from a smart phone. Coupons or even merchant loyalty points that a consumer is unable to use can be sent, sold and/or traded to other users of the system of the present invention. To use the PXT Money system (the name used for the present invention herein) consumers simply download the application to their mobile device (such as their Ipad or smartphone), register with the system and select which PXT Money merchants they would like to receive offers from or share in loyalty points in.

Merchants initiate a PXT Money transaction in the system. by asking the consumer for their phone number. The merchant enters the consumer's telephone number in their PXT Money Merchant Application. The information is sent to PXT's Server. Upon initial registration, merchants have the option of downloading a PXT Money Merchant application for their own smart phone (which allows small and mobile businesses to utilize the system without a costly point-of-sale system), or downloading a version for a PC or tablet (such as the iPad). Merchants can also enter the information at the PXT Money merchant website if they do not have a device capable of running the merchant application.

Upon receiving the consumer's phone number, the PXT Server running appropriate software as part of the present invention checks to see if the consumer has any applicable electronic coupons for this merchant. If so the server sends the electronic coupons to the merchant who can select which specific coupon—or coupons in the case multiple coupons are available—is redeemable for the current sale. Accounting for the value of the coupon the merchant enters the payment amount required into the PXT Money application.

The PXT money application running on the PXT server sends the payment amount, coupon details if any and the merchant's name to the consumer's phone. The consumer can choose to accept the sale with or without using the coupon selected by the merchant and with or without merchant loyalty points perhaps accumulated by the consumer. To accept the sale amount and coupon offered the consumer simply enters their PIN number created when they registered with PXT Money. An acceptance notification is sent to the merchant. If multiple coupons are available and applicable to the sale, the consumer may at this point choose to select an alternate set of coupons. In this case the consumer selected coupon is returned to the merchant for acceptance and a recalculation of the payment amount. This in turn is sent back to the consumer for acceptance.

The consumer may also decline the sale, in which case a declination confirmation is sent to the merchant. Finally, the PXT system sends an acceptance notification along with a digital sales receipt. If the consumer used a coupon the coupon ID is also sent to the merchant. This step ends the transaction and the sale is finalized. While the merchant has access to numerous transaction reports digital receipts are stored and can be retrieved later for viewing or printing. Sale declination notifications may also be sent to the merchant if the customer declines the sale or if after a given period no notification at all has been sent by the customer.

As the PXT system is forwarding a sales acceptance notification to the merchant to finalize the transaction, a digital receipt is sent to the consumer's phone where it is displayed. The receipt is stored for later retrieval and printing. Consumers can also opt in and out of receiving offers from selected merchants. They can also send their coupons to other PXT Money users and even make person-to-person (P2P) payments to other consumers utilizing the same system and methodology described herein.

PXT Money is an all digital prepaid consumer purchasing solution. Each consumer has a secure prepaid account which can be topped-up from other funds source(s) (cash, checks, credit/debit cards) as necessary. Consumers control how much is in their prepaid account. PXT Money payments only use funds from the prepaid account. Person-to-person (P2P) payments can also be made using the application. In addition, a ‘coupon’ value can be used as part of the payment. Coupons however cannot be used alone—the merchant contract will obligate the merchant to accept payment using the application in conjunction with the coupon.

Consumers manage their accounts, manage the types of offers they would like to receive, and transfer coupons to other users all from the convenience of their smart phone application or via a browser from a PC or other Internet connected device. Consumers can choose to receive all offers for a given geographic area or select individual merchants they want to receive offers from.

Registered merchants who accept PXT Money define and distribute offers to targeted consumers by publishing these offers as coupons. They can also elect to use one of a variety of methods to conduct a PXT Money transaction. They can use a merchant application on a smart phone, a PXT Money merchant application on a tablet or other Windows PC as well as through a browser on any Internet capable device they may own. No special equipment is required.

Merchants initiate a PXT Money payment transaction by entering the consumer's phone number along with the purchase amount. On receipt of the payment request, PXT Money will inform the consumer whether an offer (i.e. coupon) is also available for that merchant. The consumer can either use the offer value as part of the payment or save the offer value for another time and pay the full amount with funds from their main account. The consumer also has the right to decline the payment request altogether.

However, if approved—a process that requires the consumer to enter a PIN as verification, the merchant application receives a payment acceptance notification and the sale is concluded. Both the consumer and merchant receive a digital receipt, which can be retrieved later for printing if necessary. If the consumer elected to use an available coupon, the merchant receives confirmation of which one.

Merchants also have access to end-of-day and other periodic PXT Money transaction reports while Consumers use their smart phone to purchase goods and services from merchants and redeem ‘offers’ that may be applicable to the sale all in one convenient and quick transaction.

Merchants initiate a PXT Money transaction in the system by asking the consumer for their phone number. The merchant enters the consumer's telephone number in their PXT Money Merchant Application. The information is sent to PXT's Server.

Upon initial registration, merchants have the option of downloading a PXT Money Merchant application for their own smart phone, or downloading a version for a PC or tablet (such as the iPad). Merchants can also enter the information at the PXT Money merchant website if they do not have a device capable of running the application.

Upon receiving the consumer's phone number the PXT Server checks to see if the consumer has any coupons for this. If so the server sends the details to the merchant who can select which specific coupon—or coupons in the case multiple offers are applicable—is redeemable for the current sale. Accounting for the value of the coupon the merchant enters the payment amount into the application.

### BRIEF DESCRIPTION OF THE DRAWINGS

These and other features and advantages of the present invention will be better understood by reading the following detailed description, taken together with the drawings wherein:

FIG. 1 is block diagram of the system of the present invention illustrating the steps and applications involved in completing the transaction according to the present invention.

### DETAILED DESCRIPTION OF THE PREFERRED EMBODIMENTS

The present invention features a system and method that allows a consumer to use their smart phone to purchase goods and services from merchants (or to transfer funds to other consumers in a P2P solution) and redeem “offers” made by a merchant and that may be applicable to the present sale, all in one quick and convenient transaction.

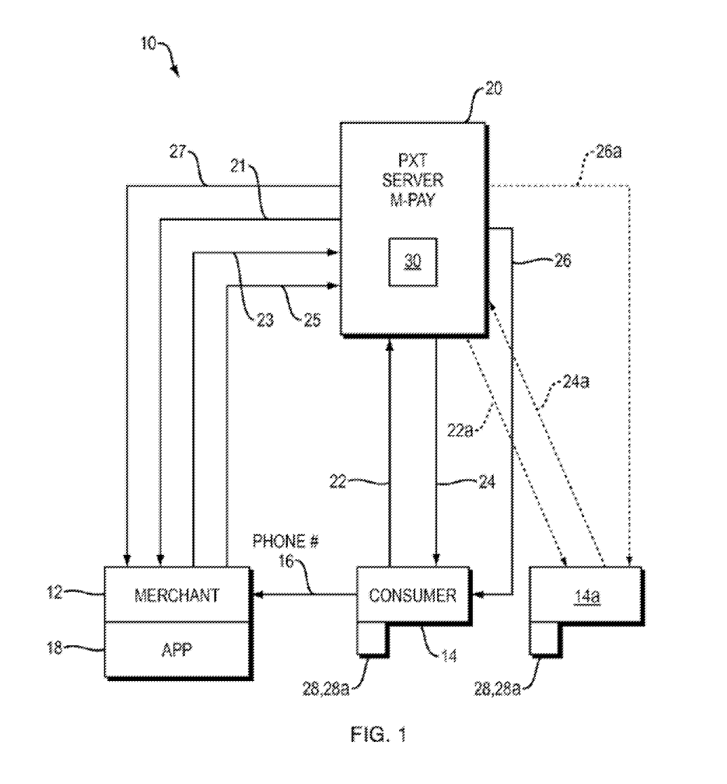

An exemplary system 10, FIG. 1, is shown on which may be initiated the method of the present invention. A merchant initiates a PXT Money transaction in the system by asking the consumer 14 for their phone number. The consumer provides his or her phone number, 16 to the merchant 12. The merchant 12 enters the consumer's telephone number 16 in their PXT Money Merchant Application 18 at the point of sale. The consumer's telephone number 16 is sent to the PXT Server 20 (23) operating appropriate software to carry out the method of the invention as described herein.

Upon initial registration, merchants have the option of downloading a PXT Money Merchant application 18 for their own smart phone, or downloading a version for a PC or tablet (such as the iPad). Merchants can also enter the information. at the PXT Money merchant website if they do not have a device capable of running the appropriate PXT money merchant application.

Upon receiving the consumer's phone number as shown at 23, the PXT Server 20 running appropriate software as part of the present invention checks to see if the consumer has any coupons for this particular merchant. The offer details and the merchants from which the consumer wishes to receive coupons rom is entered by the merchant and consumer respectively and stored in the server 20. If so, the server 20 sends the details of the offer (s) 21 to the merchant 12, who can select which specific coupon—or coupons in the case multiple offers are applicable—is redeemable for the current sale. For example if the consumer is purchasing a bicycle and the merchant has previously entered an offer that those purchasing a bicycle over the price of $100 are eligible for a 10% off coupon, the merchant can confirm that this bicycle purchased contemplated by this consumer meets the merchant's offer requirements.

Accounting for the value of the coupon the merchant enters the payment amount required into the PXT Money application which in turn send it back to the server 20, as shown at 25.

The PXT money application running on the PXT server 20 then sends the payment amount required, coupon details if any and the merchant's name to the consumer's phone, step 22. The consumer can choose to accept the sale with or without using the coupon selected by the merchant. To accept the sale amount and coupon offered the consumer simply enters their PIN number created when they registered with PXT Money and that is transmitted back to the server, as shown at 24. An acceptance notification is then sent from the server 20 to the merchant 12 as shown at 27. If multiple coupons are available and applicable to the sale, the consumer may at this point choose to select an alternate offer. In this case the consumer selected coupon is returned to the merchant for acceptance and a recalculation of the payment amount. This in turn is sent back to the consumer for acceptance.

The consumer may also decline the sale, in which case a declination confirmation is sent to the merchant. Finally, the PXT system sends an acceptance notification along with a digital sales receipt to the merchant 27. If the consumer used a coupon the coupon ID is also sent to the merchant. This step ends the transaction and the sale is finalized. While the merchant has access to numerous transaction reports digital receipts are stored and can be retrieved later for viewing or printing. Sale declination notifications may also be sent to the merchant if the customer declines the sale or if after a given period no notification at all (PIN acceptance) has been sent by the customer.

As the PXT system is forwarding a sales acceptance notification to the merchant to finalize the transaction 27, a digital receipt is sent to the consumer's phone 26 where it is displayed. The receipt can be stored for later retrieval and printing. Consumers can also opt in and out of receiving coupons from all or selected merchants. They can also send their coupons to other PXT Money users and even make person-to-person (P2P) payments to other consumers utilizing the same system and methodology described herein.

The present invention utilizes several software solutions call the PXT Mobile product suite. The PXT Mobile product suite incorporates the functionality of both PXT Mobile Debit and Parcxmart Mobile. Both of the aforementioned products share a common core payment platform, PXT M-Pay which operates on server 20 in the internet cloud.

PXT M-Pay™ is a payment platform provided by the assignee of the present invention and incorporated herein by reference that provides the functions needed to acquire, process and settle payment transactions, establish and manage customer accounts, and provide in-house management functions such as reporting, security, archiving and backup.

PXT Mobile Debit™ is a mobile payment system application, building upon PXT M-Pay, that enables consumers to purchase goods and services using their smart phones from merchants who themselves require no specialized equipment except a device that is connected to the Internet. Integral to the PXT Mobile Debit solution is a value-based offer feature that allows merchants to design special offers and distribute those offers to PXT Mobile consumers. PXT Mobile Debit provides the functions needed to define and manage merchant offers, distribute offers to consumers, and report on these offers.

Parcxmart Mobile™, building on PXT M-Pay, that enables a consumer—for example a parker parking a car in a city in this case—to purchase parking time using their smart phone at a parking space owned by a city. The solution provides a smart phone payment application for the parker as well as a mobile application for use by the city's enforcement team to check the status of a parked vehicle whose driver has paid for the space using Parcxmart Mobile 28 operating on the consumer's smart phone.

Parcxmart Mobile 28 provides the functions to define and manage parking location and rate information and provide that information to ‘parkers’ so they can purchase time at a space.

PXT M-Pay™ provides all of the payment functions needed to support the PXT Mobile Debit and Parcxmart Mobile applications and their users. All transactions between a merchant and consumer and between the parker and city are managed, acquired, stored, processed and financially settled by the PXT M-Pay system. All financial account registration, verification and management functions are provided by the system whether it be the registration of a consumer, merchant or city.

Three primary components exist within the PXT M-Pay system; a Transaction Component, a Customer Management component and a PXT Management component. These components and the functions each one supports are described in the pages that follow.

PXT Mobile Debit™ 28 enables a consumer to purchase goods and services from merchants using an application on their smart phone. Both the consumer and merchant must be registered with PXT Mobile to participate in a transaction. The consumer registration process requires the consumer's email address, a password and the device ID of the smart phone they will use to make payments. The process is initiated when the PXT Mobile Debit consumer application 28, downloaded from their phone's appropriate ‘Apps Store’, is first run on the consumer's phone.

On verification that the necessary registration information has been provided, an account is created. The account, which is a prepaid account, has a funds component into which the consumer adds currency value; it is this value that is debited when the consumer makes a PXT Mobile Debit purchase. Consumers may elect to nominate a bank account from which funds will be transferred to the consumers PXT Mobile Debit account using the federally controlled ACH system (preferred) or they may choose to fund their account (a “funded account”) using a credit or debit card through an online mechanism such as PayPal, or the consumer may load their account with cash/check at a participating merchant. When a funded account is established, the consumer may make payments at participating PXT Mobile Debit merchant stores.

Merchants register with the system through an application contract process providing contact information as well as banking information. In order to participate in a payment transaction, merchants must have a device at the point of sale that is able to run a PXT Mobile Debit merchant application 18. With that application, which can be run on a device as simple as a smart phone, electronic tablet such as an

Ipad or the like, registered merchants will be able to accept PXT Mobile Debit payments from consumers.

In addition to accepting PXT Mobile Debit payments merchants can define ‘offers’ which can then be distributed via PXT Mobile as electronic coupons to a consumers who have indicated they wish to receive them. These are short term enticements that effectively add value to a consumer's account. However, they do not increase the consumer's main account balance; all offers are managed separately. Like coupons, ‘offers’ can either be used or not, but will eventually expire. The offer value can be used by the consumer when making a purchase at the merchant that distributed the offer, or the offer can be transferred (sold, given, and traded for another offer at the same or different merchant) to another PXT Mobile Debit consumer for use at that same merchant.

Merchants always initiate a payment transaction. They do so by entering the consumer's phone number along with the purchase amount. On receipt of the payment request, the consumer will also be informed whether an offer is available for that merchant. The consumer can either use the offer value as part of the payment or save the value for another time and pay the full amount with funds from their main account. The consumer also has the right to decline the payment request altogether. However, if approved—a process that requires the consumer to enter a PIN as verification—the merchant application receives a payment acceptance notification and the sale is concluded. PXT Mobile also supports refunds.

Payments made from the system of the present invention to either a merchant or another consumer are always made through the ACH system. Once the appropriate period of time has elapsed for funds clearing from the consumer, the system of the present invention transfers the required amount of funds (less a commission paid to the operator of the system) from the system's account (into which the consumer's funds have been transferred) directly into the merchant's account utilizing the ACH process. No other funds transfer operator is utilized or required.

On conclusion of a transaction, both the consumer and merchant applications display a receipt, copies of which are stored locally on each participant's device for later retrieval. The merchant can also obtain end-of-day reports from their application as necessary. Both have the ability to go online and obtain additional reports through the PXT Mobile website where account changes can be made and other features are also available. Accordingly, the present invention is completely digital from transaction consummation to offer, point and receipt storage. No paper is required whatsoever.

In another embodiment of the invention, the system includes a points control application 30 resident on the server 20 or on another independent server. The points control application 20 handles all aspects of tracking the accumulation, use, sale, trade or barter of merchant specific loyalty points that a consumer accumulates. The merchant points are accumulated by the consumer when they purchase goods and/or services, or when the merchant decides to send a consumer merchant points in response to some promotion, offer, statistical outcome, or any other purpose. The merchant is able to define how many points are awarded in response to either a purchase (in terms of purchase value) or some other trigger that they define (for example after 5 purchases).

Merchant points can be used for purchasing goods or services at the merchant that originated the points either by themselves or in combination with PXT Money. The value of merchant points (in terms of purchasing power) is defined by the merchant issuing the points. The system does not place restrictions on the value of points in either absolute or relative terms. Merchant points can be set to expire after a certain period of time in relation to their time of accumulation. Merchant points can be gifted from one consumer to another, they can be sold to one consumer from another and/or they can be traded with other merchant points from one consumer to another. All accumulation, use and trade of merchant points is transactional and can be tracked and audited. Merchants have access to reports that allow them to monitor the distribution and redemption of points.

For example, if one consumer has accumulated 100 points at a merchant that sells bicycles but want to take his wife to dinner at a fancy restaurant and knows that his friend (or another consumer who belongs to the system of the invention) has 100 points worth $100 at the fancy restaurant, the first consumer can enter into a transaction whereby he buys the other's consumers points or sells his points or trades his points to the other consumer (assuming that other consumer might have a desire to purchase a bicycle). In this manner, the points control application 30 of the invention allows consumers to engage in transactions regarding merchant specific loyalty points.

One intended use for Parcxmart Mobile is a pay by smart phone solution for on-street parking. Using the Parcxmart Mobile application a driver can pay for time at a parking space irrespective of any other parking technology that may be in place. The City incurs no infrastructure cost when implementing Parcxmart Mobile.

A Parcxmart Mobile user will register, establish and fund an account with the PXT Mobile system in a similar way as described for a PXT Mobile Debit consumer, but will additionally have the opportunity to register one or more vehicles with their account. When the driver uses the Parcxmart Mobile application to pay for parking, they will specify the location of the space (a combination of GPS information and on-street signage will provide this information for the driver to acknowledge or enter) the registration number of the vehicle they are parking and either the length of time they wish to stay or an indication that they wish to stay for an indeterminate amount of time. In the case of the latter, the consumer will be informed of the possible maximum charge they might incur and the system will reserve that amount until the driver returns to indicate they are leaving at which time the appropriate charge will be applied and deducted from the consumer's account. Payment authorization will require the driver to enter a PIN.

A refund for unused time in the case a duration was specified and the parker returned and leaves the space earlier than expected is supported.

Cities will be subject to a contract for provision of the Parcxmart Mobile service. Parking policy (e.g. refunds for unused time), parking locations, parking rates (cost per time unit) and enforcement rules (e.g. time restrictions) are determined by the city but entered into and managed by the PXT Mobile parking management system as appropriate in support of the Parcxmart Mobile application.

City parking enforcement officers will use a mobile application to verify whether or not a vehicle whose driver has paid using Parcxmart Mobile is parked legally or not. They can do this on an individual vehicle basis or can request a list of all Parcxmart Mobile vehicles currently parked legally in a specific parking zone.

Administrative functions supporting the definition of ‘enforcement officers’ are provided, along with functions for capturing, managing and distributing parking location and rate information.

The transaction components encapsulate the core operational features of the PXT Mobile product suite that are involved in making payments, delivering promotional value, and providing parking information to the consumer, the merchant and the enforcement officer (if required).

The transaction components are defined as follows: PXT Mobile Application—this is the application 28 on a consumer mobile device that provides the PXT Mobile Debit interface allowing the consumer to view current promotions and make payments to merchants.

Parcxmart Mobile Application—this is the application 28a on a consumer mobile device that will deliver parking information and allow the consumer to pay for parking.

Merchant Application—this is the merchant application 18 for PXT Mobile Debit that enables the merchant to initiate a transaction.

Web Shopping Cart—this is the merchant shopping cart interface that can be used to initiate a web transaction.

Enforcement Application—this is the application that is resident on a parking enforcement officers' handheld device that enables the officer to verify that a car has been legally parked using Parcxmart mobile.

Transaction Acquiring—this is the server 20 component that accepts an initial transaction from one of the above client applications and initiates the transaction within the system. It also checks transaction status on request from a client application.

Session Management—this is the component that manages the overall transaction within the system, routing requests as appropriate and coordinating responses. The transaction flows are incorporated within this functional area.

Account Management—this is the component that provides account and balance related information and validation within the PXT Mobile system.

Offer Management—this is the component that provides offer related information and validation within the PXT Mobile system.

Transaction Management—this is the component that handles the validation, posting and rollback of transaction information within the PXT Mobile system.

Parking Management—this is the component that handles location, rate and occupation information for the parking infrastructure.

The customer management components encapsulate those functions that customers of the PXT Mobile product suite require to manage their accounts, add value to their accounts, provide and receive promotional offers, provide and receive parking infrastructure information and retrieve historical information.

The customer management components are defined as follows:

Consumer account management—this is the component that handles consumer registration for the product suite; viewing consumer transaction history and statements; signing up for promotional offers; viewing current balance and promotional offers; adding value to the account; subscribing to parking programs; and consumer customer service.

Merchant account management—this is the component that handles merchant registration for PXT Mobile Debit; merchant point of sale setup; viewing transaction history and statements; viewing financial settlements history; and merchant customer service.

Merchant offer management—this is the component that enables the merchant to create offers; identify the locations that an offer should be made available to; manage offers; post offers to the relevant consumer accounts; and send offer information to the targeted consumers.

City parking management—this is the component that handles city registration; allows importing of parking meter and rate information; provides management of the parking infrastructure information; provides management of the parking enforcement officer information; allows viewing of the parking transaction history and statements; and viewing of the financial settlement history.

The PXT management functions encapsulate those functions that the owner of the product suite would use to manage the accounts in the system, add new pre-authorized accounts, monitor account activity for fraud, generate statements for all parties, perform financial settlements and retrieve management statistics.

Settlement—this component provides the financial settlement between consumers, PXT Mobile, merchants and cities. The functions will generate any ACH records required for settlement and submit them to the appropriate financial partners automatically. The function will also track consumer payments and ensure they have been received.

Statement Generation—this component automatically generates statements for all parties involved in the system—consumers, merchants and cities. The statement generation component will provide statements at configurable intervals ranging from daily statements to annual statements. Planned increments are daily (business days only), monthly and annually.

Account Control—this component allows PXT to create merchant and city accounts; manage information in all consumer, merchant and city accounts; set spending limits on accounts; disable accounts; view transaction information on accounts; set appropriate fee charge schedules on the accounts; and set one time fees on the accounts.

Transaction Archival—this component moves transactions from the live database to the transaction warehouse once they are no longer required within the system, but still need to be available for audit and reporting purposes.

Security and Audit—this component enables the creation of authorized users within the system; controls access (by user) to the various available functions; allows viewing of the audit logs showing what has altered; and provides any proactive fraud reporting capabilities built into the system. Report—this component provides the reports required to successfully run the PXT Mobile product suite.

The transaction components provide the core functions involved in the initiation, acceptance and completion of all transactions in the system. This section will define both the transactions that are required in the system and the supporting functions needed to execute these transactions.

The PXT Mobile Debit Application 28 provides the consumer interface to the PXT Mobile transaction system 20. The application resides on a personal consumer device which is completely under the control of the consumer. The application is downloaded from the appropriate location (this depends on the mobile device).

When the mobile debit application is first started it will be looking for transactions that require approval for up to a predetermined amount of time such as 30 seconds, as well as offering other functions to the consumer. Once 30 seconds have passed the application will no longer look for transactions, but an option will be available to initiate the transaction approval feature.

The application will perform the following functions:

Complete Registration of the Consumer Device

Enables the consumer to complete the registration of the device with the PXT Mobile system. The function will force the consumer to enter their email address, password and phone number in order to register with PXT Mobile. Each input will be used to validate the consumer and device. The device identifier is automatically picked up from the mobile device (if different from the phone number) and used as an additional identifier. If the application fails the registration process more than three times then the consumer account is blocked. Only one mobile device can be registered with a PXT Mobile account.

The application also enables the consumer to view the outstanding balance in their PXT Mobile account. The consumer will need to enter their account PIN to access the balance. This application also enables the consumer to view the outstanding offer balances and the locations for which those balances are available.

The consumer can tailor the locations for which the balances can be viewed. If there is a GPS capability on the device the offers can be restricted by the consumer to a distance from the current GPS location of the mobile device. The consumer will need to enter their account PIN to view their current offers.

View recent receipts. Enables the consumer to view their recent receipts for purchases made using PXT Mobile. The function will allow viewing of the last 10 receipts stored on the device. Only the last 10 receipts are stored on the device. Receipts are always available online using the management system. The consumer PIN is not required for this function.

Approve transaction. Enables the consumer to approve a transaction initiated by a merchant and sent to the consumer's mobile device. The function will display the merchant information and the purchase amount entered by the merchant. The function will display any offer balances available to the consumer for the merchant initiating the transaction for the amount spent. The consumer will be able to accept or decline the use of an available offer as well as to accept or decline the transaction request sent by the merchant.

To approve the transaction the consumer must enter their PIN. If the PIN validation fails the consumer will be prompted to re-enter their PIN. If PIN validation fails more than the currently set PIN validation threshold the account will be disabled in the system.

If the transaction is approved by the consumer the application will automatically run the Get and View Receipt function.

Get and View Receipt. This function will retrieve the receipt for the currently executing transaction once the system has approved that transaction and display it to the consumer. The receipt will also be added to the consumer's locally stored receipts. If there are more than 10 receipts stored on the device the oldest one will be deleted.

Set Location. Enables the consumer to override the location that is selected using the GPS location reported by the mobile device, or to select a location where the GPS capabilities of the mobile device are not present or not functioning.

The Parcxmart Mobile Application provides the consumer interface to the parking component of the PXT Mobile transaction system. The application resides on a personal consumer device which is completely under the control of the consumer.

The application is downloaded from the appropriate location (this depends on the mobile device).

Set Location. Enables the consumer to override the location that is selected using the GPS location reported by the mobile device, or to select a location where the GPS capabilities of the mobile device are not present or not functioning.

Select Vehicle. Enables the consumer to select the default vehicle to be used in the parking transaction from the list of vehicles they have specified.

View Parking Enables the consumer to view the parking rates and times for the location they wish to park at. In the case where the GPS location is not accurate the consumer will be allowed to select from a list of possible locations within the general area. The consumer will always be allowed to override the GPS calculated location.

Park. Enables the consumer to (optionally) select a parking location and either:

1) specify the amount of time they wish to spend at the location.

2) specify they wish to start parking at the location for an indeterminate period.

If option (1) is specified the consumer is shown the amount of the parking charge and the Pay function is started.

If option (2) is specified the consumer is shown the minimum and maximum amounts they may be charged and the Reserve function is started.

The consumer may also change the vehicle they are using at this point in the transaction.

Pay. This function charges the consumer for the amount specified in the Park or Return functions.

The Pay function shows the consumer the amount they are paying, the location (where specified) that they are reserving and the duration (where relevant) that they are parking for as well as the registration number of the vehicle they are parking.

On checking the information the consumer will be asked for their payment PIN whereupon if valid the transaction will be completed. The Get and View Receipt function will be invoked on successful completion of this function.

If the PIN validation fails the consumer will be prompted to re-enter their PIN. If PIN validation fails more than the currently set PIN validation threshold the account will be disabled in the system.

Reserve. This function reserves some of the consumer's PXT Mobile balance for parking payment where the end charge is unknown. It is used only when the parking period is indeterminate.

The Reserve function shows the consumer the minimum and maximum amounts they may be paying, the location (where specified) that they are reserving and the maximum duration (where relevant) that they can park for as well as the registration of the vehicle they are parking.

On checking the information the consumer will be asked for their payment PIN whereupon if valid the transaction will be completed. The Get and View Receipt function will be invoked on successful completion of this function.

If the PIN validation fails the consumers will be prompted to re-enter their PIN. If PIN validation fails more than the currently set PIN validation threshold the account will be disabled in the system.

Return. This function indicates to the system that the consumer has completed a parking session that was set up for an indeterminate period. The consumer may also use this function to terminate an existing pre-paid parking session early and receive a refund, where this feature is enabled.

The return function first checks that there is an outstanding indeterminate parking session. If there is such a session it calculates the amount to be charged to the consumer and notifies the consumer of the amount they will be charged. This amount will never be less than the minimum nor greater than the maximum presented to them earlier.

If the cardholder is returning early to a prepaid transaction the consumer will be shown the amount they will be refunded.

On checking the information the consumer will be asked for their payment PIN whereupon if valid the transaction will be completed. The Get and View Receipt function will be invoked on successful completion of this function.

If the PIN validation fails the consumers will be prompted to re-enter their PIN. If PIN validation fails more than the currently set PIN validation threshold the account will be disabled in the system.

Get and View Receipt. This function will retrieve the receipt for the currently executing parking transaction once the system has approved that transaction and display it to the consumer. The receipt will also be added to the consumer's locally stored receipts. If there are more than 10 receipts stored on the device the oldest one will be deleted.

View recent receipts. Enables the consumer to view their recent receipts for parking made using PXT Mobile. The function will allow viewing of up to the last 10 receipts stored on the device. Only the last 10 receipts are stored on the device. Receipts are always available using the management system. The consumer PIN is not required for this function.

Other possible functions. Set alarm—set an alarm for when parking is due to expire.

Extend—add additional parking time, up to the maximum for a space.

The Merchant Application 18 resides at the merchant location on the merchant POS system, or a standalone payment device. The merchant application 18 must be online to the transaction acquirer function at all times.

Not all of the following functions will be applicable to all merchant POS deployments.

The merchant application may contain the following functions:

Set Merchant Terminal. This function assigns this terminal to the specified merchant and sets the terminal identifier. The merchant information must have been pre-registered with the PXT Mobile system by the merchant. The merchant's logon information must be specified as part of this setup.

Payment Request. Enables the merchant to request payment from a PXT Mobile consumer. The merchant enters the consumer's phone number for the mobile device they are using and the amount of the purchase and presses the Request Payment button. The function then waits for the consumer to agree to the payment. If the consumer declines payment, a Payment Request Declined message is displayed. If the consumer accepts payment an acknowledgement is displayed and the Get and View Receipt function is started.

If no payment acknowledgement has been received after a pre-determined period of time the transaction is abandoned and an error displayed.

Get and View Receipt. This function will retrieve the receipt for the completed transaction and display it to the merchant. The receipt will also be added to the merchant's locally stored receipts.

View Receipts. Enables the merchant to view receipts as required. The receipts will either be displayed from the local cache or retrieved from the server as required.

End of Day Report. This function will display the end of day status for PXT Mobile transactions providing a summary and a total for the transactions executed that day.

Refund. Enables the merchant to perform a refund against a consumer transaction that took place at this merchant. Information about the original transaction is required to execute a Refund function. The total amount refunded across multiple refunds can never be more than the original transaction amount.

The web shopping cart interface is a set of specifications that allow a merchant web based shopping cart to interface to the PXT Mobile payment system. The web shopping cart interface will allow the shopping cart's payment interface to submit a transaction through the transaction acquirer and retrieve the receipt information for the transaction it has submitted.

The Enforcement Officer Application resides on the enforcement officer's mobile device. The application enables the officer to determine if a vehicle is parked legally using the Parcxmart Mobile system. On start-up the application requests login information from the officer. This information must have been previously set up by the entity responsible for the parking operation

Check Registration. This function provides for the entry of a vehicle registration number. Once entered the registration is sent to the Parcxmart Mobile system and the system will respond with whether or not the vehicle is legally parked using the Parcxmart Mobile system.

Show Location. This function enables the selection of a parking location (for example a street, block, lot, garage floor, etc) and shows which vehicles (by registration number) are legally parked in that location. If the vehicles are parked in defined spaces the space they are parked in is also displayed.

The Transaction Acquirer receives all requests from the client device applications and passes them on to the session management component as appropriate. The Transaction Acquirer manages all security protocol functions between the client applications and the management systems.

Logging. This function will log all requests that arrive at the Transaction Acquirer. Detail recorded will include the initiating IP address, the transaction type, and any errors at the level of initial transaction acceptance.

Validate Transaction. This function will validate the transaction requests/responses received from the various client device applications by checking their security signatures and other information. If the information is incorrect the transaction will be rejected by the function and an error code returned.

If repeated validation errors are encountered from a specific IP address then the Validate Transaction function will pass the details onto the Block End Point function.

Block End Point. This function will maintain a list of blocked end-point IP addresses. All transactions received will be passed through this function to determine whether a transaction from a specific IP address should be accepted or not Blocked IP addresses are aged from the system to cope with the re-allocation of dynamic IP addresses. The function will also provide an interface to manually add and remove blocked IP addresses.

The Session Management component manages and controls the transaction flows for the entire PXT Mobile system. The session management function invokes other management functions as needed to complete a transaction. The session management component is typically initiated by the Transaction Acquirer, though the function can be initiated by any of the other management subsystems as required.

The functions in the following sections are provided by the Session Management component.

Get Balance. This function retrieves the balance for the specified consumer account. The function performs the following:

1) Executes the Account Validation function in the Account Management component to validate the consumer account.

2) Executes the Balance Retrieval function in the Account Management component.

3) Returns the balance to the initiating application.

Purchase Transaction Request. This function is initiated by the Merchant Application component and starts the purchase process with a PXT Mobile application.

The function performs the following:

1) Executes the Account Validation function in the Account Management component to validate the supplied consumer account and the merchant account.

2) Executes the Set Available Transaction function in the Transaction Manager.

3) Return a ‘poll for transaction’ response to the merchant application.

The next step in the process is for the PXT Mobile application to send a ‘purchase transaction query’ request.

Purchase Transaction Query. This function is initiated by the PXT Mobile application and requires a Purchase Transaction Request to have taken place for this merchant and consumer.

The function performs the following:

1) Executes the Check Available Transaction function in the Transaction Manager. If the function specifies there is a transaction the following steps occur, otherwise a status of ‘no transaction’ is returned.

2) Executes the Balance Retrieval function in the Account Management component for the consumer.

3) Executes the Offer Balance Retrieval function in the Offer Management component for the specified merchant and consumer.

4) Returns the balance, offer balance and transaction information to the consumer for approval.

5) Executes the Set Pending Transaction function in the transaction management component and, if applicable, the Set Pending Offer Transaction function.

The next step in the process is for the PXT Mobile application to send a Purchase Transaction Validation request.

Purchase Transaction Validation. This function is initiated by the PXT Mobile application to finalize the purchase and requires a Purchase Transaction Query to have taken place.

Executes the Check Pending Transaction function in the Transaction Management component. If no pending transaction is discovered then an error is returned.

Executes the Debit Account function in the Account Management component to determine if there are enough funds in the consumer account to cover the non-coupon part of the purchase.

Executes the Debit Offer function in the Offer Management component for the selected offer (if any) to determine offer availability and remaining balance.

Executes the Log Transaction function in the Transaction Management component which marks the transaction as complete and, if necessary, the Log Offer Transaction function in the Offer Management component.

Sends a ‘transaction complete’ status to the PXT Mobile application.

The transaction is now complete and both parties can send a ‘retrieve receipt’ request for the specific transaction executed.

Retrieve Receipt. This function is initiated by a ‘retrieve receipt’ request from either the merchant or consumer application. It is typically used for retrieving the last receipt.

The function performs the following:

Executes the Retrieve Transaction Data function in the Transaction Management component and the Retrieve Offer Transaction Data function in the Offer Management component, if required.

Sends the transaction data to the requesting application.

Get Parking Rates. This function returns the parking rates for the selected location and is initiated by the Parcxmart Mobile application.

The function performs the following:

Executes the Retrieve Parking Rates function in the Parking Management function.

Sends the parking rate information to the Parcxmart Mobile application.

Purchase Advance Parking. This function purchases parking in advance (with full payment) and is initiated by the Parcxmart Mobile application.

The function performs the following:

Executes the Account Validation function in the Account Management component for the consumer.

Executes the Debit Account function in the Account Management component.

Executes the Log Transaction function in the Transaction Management component.

Executes the Update Parking Space function in the Parking Management component.

Sends the transaction complete result to the PXT Mobile application.

Register Device. This function validates that a mobile device can be used with a PXT Mobile account.

The function performs the following:

Executes the Device Validation function in the Account Management component. Returns the result to the consumer device.

Get Offer Balance. The function returns the outstanding offer balance information for a merchant transaction,

The function performs the following:

Executes the Account Validation function in the Account Management component.

Executes the Get Valid Offers function in Offer Management component.

Returns the list of allowed offers to the consumer device.

List Offers. This function returns the available offers for a merchant or area.

The function performs the following:

Executes the Account Validation function in the Account Management component.

Executes the Get All Offers function in the Offer Management component. Returns the list of offers to the consumer device.

Get Vehicle List. This function returns the list of vehicles registered to this account from the Account Management component.

The function performs the following:

Executes the Account Validation function in the Account Management component.

Executes the List Vehicles function in the Parking Management component. Returns the list of registered vehicles to the consumer device.

Reserve Parking Space. This function reserves a parking space from a specific time of day until the consumer notifies the system that they have left, or until the end of day or maximum time is reached.

This function performs the following:

Executes the Account Validation function in the Account Management component.

Executes the Reserve Funds function in the Account Management component.

Executes the Log Transaction function in the Transaction Management component for a pending transaction.

Executes the Update Parking Space' function in the Parking Management component. Returns the response to the consumer device.

Return to Parking Space. This function releases a parking space at a specific time of day and charges the consumer for the length of time parked.

This function performs the following:

Executes the Account Validation function in the Account Management component.

Executes the Check Outstanding Space function in the Parking Management component.

Executes the Commit Funds function in the Account Management component.

Executes the Commit Transaction function in the Account Management component.

Executes the Update Parking Space function in the Parking Management component. Returns the response to the consumer device.

Refund. This function refunds a previous charge or part of a previous charge. This function can only be executed by the Merchant Application or the system.

This function performs the following:

Executes the Account Validation function in the Account Management component.

Executes the Retrieve Transaction Data function in the Transaction Management component and, if necessary, the Retrieve Offer Transaction Data in the Offer Management component.

Checks the original transaction has not been reversed beyond the amount being requested for the refund.

Executes the Credit Offer function in the Offer Management component if an offer was used for the purchase, up to the maximum value of that original offer.

Executes the Credit Account function in the Account Management component if any PXT Mobile account value was used up to the maximum value of the account. [MI: will there be a PXT imposed maximum account value?]

Executes the Log Transaction function in the Transaction Management component referencing the original transaction being reversed. Returns the response to the merchant terminal.

Check Registration. This function checks the registered vehicle is legitimately parked.

The function performs the following:

Executes the Officer Validation function in the Parking Management component.

Executes the Check Vehicle function in the Parking Management component. Returns the response to the enforcement device.

List Vehicles. This function returns the list of vehicles a consumer has registered.

The function performs the following:

Executes the Account Validation function in the Account Management component.

Executes the List Vehicles function in the Parking Management component. Returns the list of vehicles to the consumer device.

Register Terminal. This function registers a merchant terminal with the system.

The function performs the following:

Executes the Account Validation function in the Account Management component.

Executes the Register Terminal function in the Merchant Management component. Returns the result to the merchant terminal.

Merchant End of Day. This function returns the merchant's transactions for the specified day.

The function performs the following:

Executes the Account Validation function in the Account Management component.

Executes the Retrieve Transaction Data function in the Transaction Management component. Returns the transaction data to the merchant terminal.

The Account Management component provides functionality to support the validation, query and updating of account information and balances for consumers, merchants and parking management and enforcement entities (cities). The Account Management functions are accessed by the Session Manager and the management components.

The following sections detail the functions provided by the Account Management component.

Consumer Account Management. This section details the functions relating to consumer accounts.

Create Consumer Account. Creates a consumer account in the system. At this point the account is inactive. The account is activated by using the Activate Consumer Account function. Creating the account generates an activation code for that account.

Activate Consumer Account. Activates a consumer account that was previously created using the Create Consumer Account function. An activation code is required to perform this function.

Account Validation. Checks that the specified consumer account is present in the system, that the phone number and device used match and that the specified PIN is correct if required.

Balance Retrieval. Returns the current available balance for a consumer account.

Debit Account. Checks the balance and then updates it by the specified amount if the new balance fits within the allowed parameters. If the balance would fall outside the specified parameters the debit will fail.

Credit Account. Credits the specified account by the given amount as long as the credit does not exceed the account parameters.

Provisional Credit. Provisionally credits an account with a specified value. The value is not available for use by the account, but is listed as pending in the account balance view. The provisional credit transaction is logged in the transaction listing.

Release Credit. Makes a provisional credit active in the account. The value is moved from being provisionally available to being fully available for use by the account. The Release Credit transaction is logged in the transaction listing.

Set PIN. Causes a new PIN value to be set for the specified consumer account.

Device Validation. Checks that the specified mobile device is registered to the consumer requesting registration.

Register Device. Registers the specified mobile device to the consumer's PXT Mobile account. If a mobile device is currently registered to this account the registration will fail. Only one mobile device can be registered to a consumer account. On adding a mobile device associated to a PXT Mobile account the account owner will be sent an email notification.

Remove Device. Removes the currently specified mobile device from the consumer's PXT Mobile account. When the device is removed the account will become inactive until a new device is registered.

On removing a mobile device associated to a PXT Mobile account the account owner will be sent an email notification.

Merchant Account Management. This section details the functions related to merchant accounts.

Create Merchant Account. Creates a merchant account in the system. At this point the account is inactive. The account must be confirmed by both the merchant and PXT and then activated. Creating the account generates a confirmation code for that account.

Confirm Merchant Account. Confirms that a merchant account created using the Create Merchant Account function was a valid request from the perspective of the merchant. Confirming an account does not validate that account but does ensure that the request was initiated by the owner of the email address.

Activate Merchant Account. Activates a merchant account that was previously created using the Approve New Merchant function. An activation code is required to perform this function.

Change Bank. Changes the banking details associated with a merchant account.

Update Merchant Information. Updates the business name, address, contact details and other key merchant information stored by the system.

Propose New Merchant. Causes a request to be sent to the PXT merchant approval process to approve the merchant. The merchant approval process is outside the scope of this document. The merchant account will be marked to signify that approval is in process.

Approve New Merchant. Causes a merchant account activation code to be generated.

Activate Merchant Account. Causes a merchant account to be moved to an active state. The function is supplied with a merchant activation code which is validated against a previously stored code to validate the activation request. The activation code is generated as part of the merchant approval process.

Add POS Identifier. Adds a new POS identifier to the list of valid POS identifiers for the specified merchant.

Delete POS Identifier. Removes an existing POS identifier from the list of valid POS identifiers for the specified merchant.

City Account Management. This section details the functions related to merchant accounts.

Create City Account. Creates a city account in the system. At this point the account is activated. A primary email address must be specified for the administrator of the account at this point.

Change Bank. Changes the banking details associated with a city account.

Update City Information. Updates the city name, address, contact details and other key city information stored by the system.

Offer Management. The Offer Management component provides functionality to support retrieving information on, managing and publishing offers. The offer management component also creates and manages current offer balances related to consumer accounts.

The following sections detail the functions provided by the offer management component.

Consumer Offer Management. This section details the offer management functions relevant to the consumer offer management.

Get Valid Offers. Returns all of the current active offers and offer information for the specified merchant and consumer.

Add Offer. Adds an offer for the specified consumer account.

Offer Balance Retrieval. Returns the current available balance for the specified consumer account and merchant offer.

Debit Offer. Checks the balance of the specified offer and then updates it by the specified amount if the new balance fits within the allowed parameters.

Credit Offer. Credits the specified offer by the given amount as long as the credit does not exceed the offer parameters.

Add Offer City. Adds a new offer city to the list of cities attached to a consumer account. When the function is activated the system will check the list of currently active offers for the city and, if any are available, add those offers to the consumer's account. Offers that are only available at the time of offer publishing will not be added to the account.

Remove Offer City. Removes a city from the list of cities that the consumer wishes offers from. Removing an offer city has no effect on the consumers currently active offers.

Send Offer. Sends an offer to a PXT Mobile friend who does not have the offer. The offer must be marked as transferable and the friend must not already have, or have used, the offer.

The friend will be sent an email notifying them that they have a new offer.

Change Offer Profile. Updates the offer profile information stored about a consumer account. This offer profile information may be used by merchants to specify which consumers they wish to send offers to.

Merchant Offer Management. The merchant offer management component contains the functions that create and manage offers from merchants to consumers.

Get All Offers. Returns all of the offers for the specified merchant. This function works in conjunction with the Account Management component.

Create Distribution Profile. Creates a distribution profile in the system for the specified merchant account.

Create Offer. Creates an offer in the database that can later be published. The function requires all of the offer information, except for the distribution profile, to be provided.

Attach Distribution Profile. Attaches a distribution profile to an existing offer that has not yet been published. Multiple distribution profiles can be attached to an offer before it has been published.

Publish Offer. Publishes an offer in the system. The offer will be added to all consumer accounts that match the distribution profiles as a promotional offer at the time of publishing. A promotional offer can only ever be added to an account once.

If a maximum number of consumer distributions are specified in the offer and the result set from the profile is larger than maximum number allowed an error will be returned and the publish cancelled. All consumer accounts that receive the offer will also receive email notification that they have a new offer.

Update Offer Duration. Updates the duration of an offer in the system. All consumer accounts that currently have the offer active will have the duration of the offer updated.

Discontinue Offer. Stops the offer in the system. Any outstanding offer balances are rendered invalid.

Transaction Management. The Transaction Management component provides functionality to support the creation, updating and reporting of transaction information within the PXT Mobile system. The transaction management system manages Consumer Account and Offer transactions as two separate entities. All Offer transactions are linked to a Consumer Account transaction. The Transaction Management functions are accessed by the Session Manager and the management components. The following sections detail the functions provided by the Transaction Management components.

Consumer Account Transactions. This section details the functions provided for consumer account transactions.

Set Available Transaction. Stores a new proposed transaction and marks it as available for a specific merchant/consumer combination.

Check Available Transaction. Checks that a consumer has a transaction available to them and returns the transaction information to the requesting party.

Set Pending Transaction. First checks the transaction specified is in the ‘available’ state. If not an error is returned. If the transaction is available changes the transaction state to ‘pending’ to signify that the consumer device has started the transaction process.

Check Pending Transaction. Checks that a transaction is in the pending state and returns the status to the requesting component.

Cancel Transaction. Determines if a transaction is either available or pending, if so it cancels the transaction, marking it as cancelled in the system. If the transaction is neither pending nor available an error is returned.

Log Transaction. Marks a transaction as completed in the transaction database, if pending. If the transaction is marked as ‘available’ an error is returned.

Log Transaction can also be used to create a new transaction.

Retrieve Transaction Data. Returns the requested transaction data. Filters are available to determine the data to be returned.

Offer Transactions. This section details the functions provided for offer transactions.

Set Pending Offer Transaction. Stores a new proposed offer transaction and marks it as pending for a specific consumer transaction.

Cancel Offer Transaction. Determines if an offer transaction is pending, if so it cancels the transaction, marking it as cancelled in the system. If the offer transaction is not pending or does not exist an error is returned.

Log Offer Transaction. Marks an offer transaction as completed in the offer transaction database, if pending. If the transaction is not pending or does not exist an error is returned.

Log Offer Transaction can also be used to create a new transaction.

Retrieve Offer Transaction Data. Returns the requested offer transaction data. Filters are available to determine the data to be returned.

Parking Management. The Parking Management component provides functionality to support the occupation of parking spaces, reporting of parking locations and rate information, and the updating and reporting of occupied spaces. The Parking Management functions are accessed by the Session Manager and the management components.

The following functions are provided by the Parking Management component.

Get Vehicle List. Returns the list of vehicles assigned to a PXT Mobile consumer. The response will identify the default vehicle.

Add Vehicle Registration. Adds a vehicle registration to the list of vehicles a consumer may select when using Parcxmart Mobile.

Remove Vehicle Registration. Removes the specified vehicle from the list of vehicles a consumer may select when using Parcxmart Mobile.

Set Default Vehicle. Sets the default vehicle to be used when parking with Parcxmart Mobile.

Retrieve Parking Rates. Returns the available parking rates for the specified city, zone and location. The location specification is optional.

Update Parking Location. Adds a vehicle to the legitimately parked vehicles in a city. If a specific location or zone is specified then that is added to the parking location information.

Create Enforcement Officer. Creates a new enforcement officer login to be used for checking vehicle registrations in the system.

Officer Validation. Validates the login credentials for an enforcement officer.

Check Vehicle. Checks a vehicle registration to see if it is validly parked in the specified city. The query will return the zone and location the vehicle has been parked in and the time the parking session will expire. All check vehicle requests are logged in the system for audit and dispute handling purposes.

Register User. Creates a new user account for the specified city in the system. The user account is not yet active.

Activate User Account. Activates a previously registered user account in the system. The user account has no privileges assigned at this point in time.

Set User Account Privileges. Sets the privileges associated with a user account to the levels specified.

Retrieve User Accounts. Retrieves all user accounts associated with a city.

Create Parking Rate Profile. Creates a new parking rate profile for a specific city that can be used to set the rates for parking zones and locations and thus generate pricing for consumers.

Update Parking Rate Profile. Modifies an existing parking rate profile.

Retrieve Parking Rate Profiles. Retrieves a list of current parking rate profiles for a city.

Create Parking Zone. Create a new named parking zone for a specific city. The parking zone has both a default and a specific parking rate profile associated with it. The zone may contain parking locations.

Create Parking Location. Create a new named parking location for a specified zone. The parking location may have a parking rate profile associated with it. If no profile is associated with the location the default parking rate profile for the zone is used.

Update Zone Profile. Updates either the default or the specific parking rate profile associated with a parking zone.

Retrieve Parking Zones. Retrieves a list of parking zones defined for a city.

Update Location Profile. Updates the parking rate profile associated with a parking location.

Move Location. Moves a parking location from one zone to another.

Retrieve Parking Locations. Retrieves a list of parking locations defined for a parking zone.

Customer Management Component. The Customer Management components encapsulate those functions that customers of the PXT Mobile product suite require to manage their accounts, add value to their accounts, provide and receive promotional offers, provide and receive parking infrastructure information and retrieve historical information.

Consumer Account Management. This is the component that provides the functions to allow the consumer to manage their PXT Mobile account. This component interfaces into the core transaction components as required. Note that all Consumer Account Management functions that access an existing consumer account force the consumer to log in to the system using the email address and password specified in the Consumer Registration function.

The Consumer Account Management component provides the following functions:

Consumer Registration. Provides the consumer with the ability to create a PXT Mobile account. The creation of the account automatically gives the consumer access to both the PXT Mobile and the Parcxmart Mobile functionality within the system.

The function performs the following:

Requests an email address, password and mobile phone number to facilitate registration.

Executes the Create Consumer Account function in the Account Management component Sends a confirmation email to the specified email address for activation of the account, which includes an activation code to be used in the Consumer Activation function.

Consumer Activation. Enables the consumer to activate a previously registered account. The activation is completed by using the activation code sent to the consumer using the Consumer Registration function. This function uses the Activate Consumer Account function in the Account Management component using the activation code entered by the consumer.

Set Mobile Payment PIN. Enables the consumer to set or change their mobile payment account PIN. This function performs the Set PIN function in the Account Management component. An email will be sent to the consumer's account notifying them that their PIN has been changed.

Reset Account PIN. Enables the consumer to reset their payment PIN and will re-enable a previously disabled account where the PIN has been incorrectly entered a number of consecutive times. The function performs the Set PIN function in the Account Management component. An email will be sent to the consumer's account notifying them that their PIN has been changed.

Change Offer City. Enables the consumer to add or remove the cities for which they wish to receive offers. The function will use the Add Offer City and Remove Offer City functions in the Account Management component to modify the list of cities that the consumer is registered for.

Change Offer Merchants. Enables the consumer to add or remove specific merchants that they do, or do not, wish to follow for offers. The function will use the Add Offer Merchant and Remove Offer Merchant functions in the Account Management component. When a consumer account is first registered for a city all merchants are automatically followed.

Change Offer Profile. Enables the consumer to change the information stored in their offer profile. The offer profile is used when merchants target offers to specific types of consumers. The function will use the Change Offer Profile function in the Account Management component.

Send Offer. Enables the consumer to send an offer to another PXT Mobile consumer who does not have the offer. The function will use the Send Offer function in the Account Management component.

Change Vehicle Registrations. Enables the consumer to add or remove the vehicles they typically use to park using Parcxmart Mobile. The process will allow the consumer to select a default vehicle to use if they specify more than one vehicle.

The function will use the Add Vehicle Registration and Remove Vehicle Registration functions in the Account Management component.

Validate Bank Account. Enables the consumer to register and validate a bank account that can be used to add value to their account. The mechanism for validating that the account belongs to the consumer will be defined in a lower level specification.

Add Value. Enables the consumer to add value to their PXT Mobile account either using a bank account with ACH or using credit and/or debit cards. The function will ensure that funds are available from the consumer before adding value to the account. The function will also support the ability to charge the consumer for adding funds to their account depending on both the mechanism used and the amount added. The function will use the Credit Account, Provisional Credit and the Release Credit functions in the Account Management component.

View Balances. Enables the consumer to view the current balance of their PXT Mobile account as well as the balances of any offers they have available to them. Offers with a zero balance are not displayed. The function will use the Balance Retrieval function in the Account Management component to display the account balance and the Get Valid Offers and Offer Balance Retrieval functions in the Account Management component to get the balances for the currently available offers.

View Transactions. Enables the consumer to view their transaction history for the last 2 months.

View Statements. Enables the consumer to view their monthly statements. The statements will be listed by year and month. Each statement will contain the transactions for the selected calendar month.

Assistance. Enables the consumer access to any FAQ information, phone numbers for customer support, on-line chat support and email support. The features available here are outside the scope of this specification.

Merchant Account Management. This component allows merchants to set up and manage their accounts and the offers they provide to PXT Mobile consumers. This component interfaces into the core transaction components as required. Note that all Merchant Account Management functions that access an existing merchant account force the merchant to log in to the system using the email address and password specified in the Merchant Registration function.

The Merchant Account Management component provides the following functions:

Merchant Registration. Enables the merchant to start the process of registering their business to be a PXT Mobile merchant. The merchant will use an email address and password to use as their log in information for the account.

The function performs the following:

Requests an email address and password to facilitate registration; Executes the Create Merchant Account function in the Account Management component; and Sends a confirmation email to the specified email address for confirmation of the account registration, which includes a confirmation code to be used in the Merchant Confirmation function.

The merchant registration process is a multi-step process in which the final steps of activating a merchant are controlled by PXT.

Merchant Confirmation. Enables the merchant to confirm a previously registered merchant account. The confirmation is completed by using the confirmation code sent to the merchant using the Merchant Registration function. The function uses the Confirm Merchant Account function in the Account Management component using the confirmation code entered by the merchant.

Change Banking Information. Enables the merchant to add or change the banking information that is used to credit or debit the merchant's banking account when end of day settlement occurs. The function uses the Change Bank Details function in the Account Management component.

Change Merchant Information. Enables the merchant to change the business information that is used for promotional offers and for PXT to validate the merchant's suitability to join the program. The function uses the Update Merchant Information in the Account Management component.

Merchant Participation Request. Enables the merchant to apply to be a part of the PXT Mobile solution. The merchant will automatically be stepped through the Change Banking Information and Change Merchant Information functions if the information is not already present in the system. Once all information is present in the system the Propose New Merchant function in the Account Management component is executed to start the merchant approval process. The merchant approval process is outside the scope of this specification.

Activate Merchant Account. Enables the merchant to activate their account by entering an account activation code provided to them by PXT. The code will be validated by the Activate Merchant Account function in the Account Management component.

View Transactions. Enables the merchant to view their transaction history for the last 2 months. The transactions can be filtered and sorted as required.

View Statements. Enables the merchant to view their daily and monthly statements. The statements will be listed by year and month. Each statement will contain the transactions for that calendar month or day as appropriate.

Change POS Terminals. Enables the merchant to add or delete unique POS identifiers where they have multiple POS devices submitting PXT Mobile transactions. These POS identifiers are recorded as part of the transactions used. POS identifiers are not mandatory, but if they are used then POS transactions will be rejected if the POS identifier is not present.

This function uses the Add POS Identifier and Delete POS Identifier functions in the Account Management component.

Assistance. Enables the merchant access to any FAQ information, phone numbers for merchant support, on-line chat support and email support. The features available here are outside the scope of this specification.

Merchant Offer Management. This component enables merchants to create, manage and distribute offers to PXT Mobile consumers.

Note that all Merchant Offer Management functions that access an existing merchant account force the merchant to log in to the system using the email address and password specified in the Merchant Registration function of the Merchant Management component.

The Merchant Offer Management component provides the following functions:

Create Distribution Profile. Enables the merchant to create a distribution profile describing the location(s) that the offer will be targeted to and the profile(s) of PXT Mobile consumers within that location to be targeted by the offer. These distribution profiles are attached to offers during the Create Offer stage.

The Create Distribution Profile function in the Offer Management component is used to create a distribution profile.

Create Offer. Enables the merchant to create a new offer for PXT Mobile consumers. The merchant can specify a number of available offer parameters, which minimally must include offer duration, a distribution profile and the amount of the offer.

The function performs the following:

Creates the initial offer by calling the Create Offer function in the Offer Management component. This will specify the offer amount, duration and base parameters.

Adds a distribution profile for the offer using the Attach Distribution Profile function in the Offer Management component.

Releases the offer to consumers using the Release Offer function in the Offer Management component.

Update Offer Duration. Enables the merchant to modify the offer duration. This function uses the Update Offer Duration function in the Offer Management component.

Discontinue Offer. Enables the merchant to discontinue an already created offer. This function uses the Discontinue Offer function in the Offer Management component.

View Offer Statistics. Enables the merchant to view the current status of an offer. The merchant can view the number of consumers subscribed to the offer, the current value of promotional dollars spent with the offer, and the profile information of the consumers who have used the offer.

City Parking Management. This component enables the city to configure the parking infrastructure that they wish to be available for the Parcxmart Mobile payment application.

The component provides the following functions:

Register User. Enables a city user to register with the system to allow management of the city information, parking infrastructure and reports. The user must specify the city they are registering and the user is sent a confirmation email.

The function performs the following: Requests an email address and password to facilitate registration; Executes the Register User unction in the Parking Management component; and Sends a confirmation email to the specified email address for activation of the account, which includes an activation code to be used in the User Activation function.

Activate User. Enables a user to activate their access using the confirmation code sent in the confirmation email. The Activate User function in the Parking Management component is used to activate the user. The user is registered with no privileges to access, change or view information. A city administrator needs to provide the user with their access level.

Administer User. Enables a city administrator to set or remove access privileges for a registered user for that city. The function enables the administrator to retrieve a list of all active accounts and set privileges for each. The function uses the functions Retrieve Users and Set User Privileges to achieve this.

Create Enforcement Officer. Enables the creation of an enforcement officer in the system. The enforcement officer will be able to query parking information as required from their mobile device. The function uses the Create Enforcement Officer function in the Parking Management component.

Create Parking Rate Profile. Enables the creation of a parking rate profile to be used for setting the parking pricing for a particular zone and/or location. The parking rate profile can contain one or more allowed parking rates configured for different parking durations, times of day and subscription type. This function uses the Create Parking Rate Profile function in the Parking Management component.

Create Parking Zone. Enables the creation of a parking zone that can be selected by a consumer for payment or can be used to organize parking locations. The parking zone can contain a rate profile and a default rate profile that can be used for the parking locations it contains. This function uses the Create Parking Zone function to create the parking zone and the Retrieve Parking Rate Profile function to get a list of Parking Rate Profiles that can be associated with the parking zone. Both functions are in the Parking Management component.

Create Parking Location. Enables the creation of a parking location that can be selected or specified by a consumer. The parking location can have a parking rate profile associated with it. This function uses the Create Parking Location function to create the parking zone and the Retrieve Parking Rate Profile function to get a list of Parking Rate Profiles that can be associated with the parking location. Both functions are in the Parking Management component.

Manage Parking Zone. Enables the modification of parking rate profile information that is associated with parking zones and the removal of parking locations from parking zones.

Manage Parking Location. Enables the parking rate profile information associated with the parking location to be modified. This function also enables the parking location to be moved from one zone to another.

View Transactions. Enables a user with sufficient privileges to view transaction history for the last 2 months. The transactions can be filtered and sorted as required.

View Statements. Enables a user with sufficient privileges to view daily and monthly statements. The statements will be listed by year and month. Each statement will contain the transactions for that calendar month or day as appropriate.

PXT Management Components. The PXT management functions encapsulate those functions that the owner of the product suite would use to manage the accounts in the system, add new pre-authorized accounts, monitor account activity for fraud, generate statements for all parties, perform financial settlements and retrieve management statistics.

Account Control. This component enables the creation, management and disabling of consumer, merchant and city accounts within the system.

The following sections detail key functions and functional areas provided by the Account Control component.

Create Merchant Account. Creates a new merchant account in the system. The merchant account is created in an inactive state and must be activated by the merchant. The system provides an account activation code that can be emailed or sent to the merchant. This function uses the Create Merchant Account and Approve New Merchant functions in the Account Management component.

Create City Account. Creates a new city account in the system. The city account is created in an active state. The email address of a person designated as the overall administrator for account management must be provided by the city.

This function uses the Create City Account function in the Account Management component.

Approve Merchant Account. Approves a merchant account submitted by a merchant via the Merchant Management component. The approval will generate an activation code which is sent to the merchant via their supplied email address. This function uses the Approve New Merchant function in the Account Management component.

Decline Merchant Account. Declines a merchant account request submitted by a merchant via the Merchant Management component. An email is sent to the merchant stating that they have been declined.

Manage Merchant Account Information. Enables the information stored about a merchant to be changed, as required. This function also enables a merchant account to be disabled.

Manage City Account Information. Enables the information stored about a city to be changed, as required. This function also enables a city account to be disabled.

Manage Consumer Account Information. Enables the information stored about a consumer to be changed, as required. This function also enables a consumer account to be disabled.

Set Merchant Debit Fees. Enables the fees charged to a specific merchant for accepting payment using PXT Mobile to be configured. The merchant debit fees can be set to be a monthly fee, a per transaction fee, or a combination of both. Per transaction fees can be percentages, fixed or a combination of both. Per transaction fees can also be charged based on transaction value tiers.

Set Merchant Offer Fees. Enables the fees charged to a specific merchant for accepting payment using Offers to be configured. The merchant offer fees can be set to be a monthly fee, a per transaction fee, a per-offer fee, or a combination of all three. Per transaction fees can be percentages, fixed or a combination of both.

Set City Parking Fees. Enables the fees charged to a specific city for accepting payment using PXT Mobile to be configured. The city debit fees can be set to be a monthly fee, a per transaction fee, or a combination of both. Per transaction fees can be percentages, fixed or a combination of both. Per transaction fees can also be charged based on transaction value tiers.

Set Consumer Parking Fees. Enables the fees charged to a consumer for parking in a specific city using PXT Mobile to be configured. The consumer parking fees can be set to be a monthly fee, a per-transaction fee, or a combination of both. Per transaction fees can be percentages, fixed or a combination of both.

Set Consumer Value Load Fees. Enables the fees charged to a consumer for loading value into a PXT Mobile account to be configured. The consumer value load fees can be set to be a monthly fee, a per transaction fee, or a combination of both. Per transaction fees can be percentages, fixed or a combination of both. Consumer value load fees can also be set by payment type such as ACH, debit, credit, etc.

Settlement. This component provides the financial settlement between consumers, PXT Mobile, merchants and cities.

Generate ACH. Generates an ACH file detailing all of the funds movements between the various financial entities in the PXT Mobile payment system. The ACH will cover all account transactions and fee transactions that have taken place since the last ACH was generated. The function will generate one or more files suitable for submission to the Federal ACH system. The time of ACH generation will be configurable within the system and can be run in both an automated and a manual fashion.

Post ACH. Enables the automated or manual posting of an ACH file to a banking partner. This function will automatically execute after an automated Generate ACH function has run. The function will post ACH files that have not been posted since the function was last executed.

Check Payment Received. Enables the checking of credit or debit card transaction credits or ACH credits to the PXT system as a result of a consumer adding value to an account.

Statement Generation. This component automatically generates statements for all parties involved in the system—consumers, merchants and cities. The statement generation component will provide statements at configurable intervals ranging from daily statements to annual statements. Planned increments are daily (business days only), monthly and annually.

Transaction Archival. This component moves transactions from the live database to the transaction warehouse once they are no longer required within the system but which still need to be available for audit and reporting purposes.

Security and Audit. This component allows the creation of authorized users within the system; controls access (by users) to the system's functions; allows viewing of the audit logs showing what has been altered; and provides any proactive fraud reporting capabilities built into the system.

Report. This component provides the reports required to successfully run the PXT Mobile product suite.

Key Entities. This section describes the key entities within the system and which components manage those entities. This section is not intended to fully describe the data stored within each entity, but it does describe the features provided by the entity.

Consumer Account. The Consumer Account is a representation of a PXT Mobile consumer and their interaction with the PXT Mobile system. The Consumer Account is managed by the Account Management component. A consumer account, once created, can never be deleted. The account can, however, be disabled.

The Consumer Account maintains one or more of the following:

The consumer's account number (this is generated by the system and not available to the consumer); The consumer's account access information; The consumer's mobile phone number; The available balance in the consumer's PXT Mobile account; The pending balance in the consumer's PXT Mobile account; The consumer's profile information; The cities the consumer wishes offers for; The merchants the consumer does not want offers for; The consumer's preferences; and The account status.

Merchant Account. The merchant account is a representation of a PXT Mobile merchant and their interaction with the PXT Mobile system. The Merchant Account is managed by the Account Management component. A Merchant Account, once created, can never be deleted. The account can, however, be disabled.

The Merchant Account maintains: The merchant's account number (this is generated by the system); The merchant's account access information; The merchant's profile information; The merchant's banking information; and The account status.

City Account. The city account is a representation of the Parcxmart Mobile city and its interaction with the Parcxmart Mobile system. The City Account is managed by the Account Management component. A City Account, once created, can never be deleted. The account can, however, be disabled. The City Account maintains: The city's account number (this is generated by the system); The city's account access information; The city's profile information; The city's banking information; and The account status.

Offer. Offers are promotional items created by merchants and distributed to consumers. An offer has two components—the offer description and parameters; and the current consumer offer balance. The offer is managed by the Merchant Offer Management component. Offers, once generated, are sent to a specified number of consumers based on the target profiles specified in the attached Offer Distribution Profile. This profile is also used to determine whether a new consumer that signs up is eligible for an offer.

An Offer once created can never be deleted. The offer can, however, be discontinued. The Offer itself maintains: The offer identifier (this is generated by the system); The merchant owning the offer; The Offer Distribution Profile (see Offer Distribution Profiles); The value of the offer; The start date and time of the offer; The end date and time of the offer; If the offer can be partially used; The minimum purchase value required for the offer to be valid; The maximum purchase value allowed for the offer to be valid; If the offer is transferable; The maximum number of offers to be distributed; If the offer should be made available to consumers who sign up after the offer is published; and The offer status.

Offer Balances are the components of an offer that are related to a consumer account. An Offer Balance only maintains the current balance associated with the offer. The offer balance is managed by the Offer Management component. The offer balance itself maintains: The offer identifier; The merchant owning the offer; The current offer balance; and A flag specifying whether or not the offer has been transferred.

Offer Distribution Profiles. Offer Distribution Profiles specify the types of consumers that an offer is distributed to. The profiles are designed to use information provided by the consumer to target the offers, if targeting is desired by the merchant. Offer Distribution Profiles are managed by the Merchant Offer Management component.

An Offer Distribution Profile maintains: The offer distribution profile identifier (generated by the system); The profile name; The merchant owning the profile; and The profile parameters that should match for the offer to be distributed.

Parking Zones and Locations. Parking zones and locations are used to set up the parking infrastructure to allow consumers to pay for parking and validate the location or zone they wish to park in. The definition of what constitutes a parking zone and a parking location can be specified by the city. Parking zones can contain parking locations to allow structure within the parking infrastructure.

The parking zone maintains: The parking zone identifier (generated by the system); The parking zone name; The city owning the zone; The default parking rate profile for the zone (used if a location has no defined profile or the zone has no locations); and The parking locations contained within the zone.

Parking locations are contained within parking zones. Each parking location maintains: The parking location identifier (supplied by the city); The parking zone the location belongs to; The parking rate profile for the location (if none, the default is used); and The parking payment methods allowed.

Parking Payment Methods. Parking payment methods are used to define how a consumer may pay for their parking using the Parcxmart Mobile system.

The payment methods supported are:

Fixed payment—the consumer specifies a length of time they wish to park for and that amount is deducted from their account. There are no refunds.

Fixed payment with Refund—the consumer specifies a length of time they wish to park for and that amount is deducted from their account. If the consumer returns early they can be refunded for unused time.

Open ended—the consumer registers a parking start time and is charged when they specify that they have left the space or when the time limit associated with the zone/location has expired.

Pre-paid Voucher—the consumer purchases an electronic parking voucher for a fixed length of time that can be used to park in this zone or location.

Subscription—the consumer has purchased the right to unlimited parking in a zone or location for a daily, weekly or monthly period.

Parking Rate Profiles. Parking rate profiles contain various parking rates that can be associated with various parking zones and locations. The parking rate profile is managed by the Parking Management Component.

The Parking Rate Profile maintains: The profile identifier (generated by the system); The profile name; The city owning the profile; The minimum parking charge; The maximum parking charge; and The parking rates applicable to the profile.

Parking Rates. Parking rates specify the actual parking rates and are used to define parking rate profiles. Each parking rate maintains: The parking rate identifier; The city owning the parking rate; The rate per hour; The start time of the rate enforcement; The end time of the rate enforcement; and The maximum number of hours for this rate.

Accordingly, the present invention provides a novel and non-obvious system and method for facilitating electronic payment of goods and services between consumers and merchants utilizing a non-traditional financial account using the consumer's smart phone to view and approve the transaction which is paid for from a user's pre-funded account. The system and method also allows for a merchant to send the consumer an offer in connection with the transaction or not in connection with the offer, and for the consumer to accept or transfer the merchant offer to another consumer. The invention also allows for the payment of funds from one consumer to another.

Although the present invention has been explained in connection with one or more specific implementations (for example a parking payment system), this is not a limitation of the invention as the invention may be implemented in nearly any and all retail, wholesale and/or service sectors. Modifications and substitutions by one of ordinary skill in the art are considered to be within the scope of the present invention, which is not to be limited except by the allowed claims and their legal equivalents.

What is claimed is:

1. A method for use in a system having a plurality of users comprising a first user and a second user, the method comprising an act of:
(A) facilitating an exchange between the first user and the second user, the exchange involving a transfer of first indicia of value from the first user to the second user and a transfer of second indicia of value from the second user to the first user, the first indicia of value comprising one or more points or coupons usable in a transaction with only a first merchant, the second indicia of value comprising one or more points or coupons usable in a transaction with only a second merchant;
wherein a transaction with either the first merchant or the second merchant involves payment to the first merchant or the second merchant accomplished via a mobile device.

2. The method of claim 1, wherein the act (A) comprises facilitating an exchange involving a transfer of the first indicia of value and currency from the first user to the second user, and a transfer of the second indicia of value from the second user to the first user.

3. The method of claim 1, wherein the system comprises a payment processing server with which mobile devices employed by the first user and the second user communicate, and wherein the act (A) is performed by the payment processing server.

4. A computer system, comprising:
at least one processor programmed to;
facilitate an exchange between a first user of the computer system and a second user of the computer system, the exchange involving a transfer of first indicia of value from the first user to the second user and a transfer of second indicia of value from the second user to the first user, the first indicia of value comprising one or more points or coupons usable in a transaction with only a first merchant, the second indicia of value comprising one or more points or coupons usable in a transaction with only a second merchant; and
process a transaction with either the first merchant or the second merchant involving payment to the first merchant or the second merchant accomplished via a mobile device.

5. The computer system of claim 4, wherein the at least one processor is programmed to facilitate an exchange between the first user and the second user involving a transfer of the first indicia of value and currency from the first user to the second user, and a transfer of the second indicia of value from the second user to the first user.

6. The computer system of claim 4, wherein the at least one processor is programmed to process the transaction using information provided by the mobile device via at least one communications network.
